(19) United States
(12) Patent Application Publication
(10) Pub. No.: US 2007/0280270 A1
(43) Pub. Date: Dec. 6, 2007

(54) Autonomous Musical Output Using a Mutually Inhibited Neuronal Network

(76) Inventors: Pauli Laine, Espoo (FI); Juho Niemisto, Helsinki (FI)

Correspondence Address: HARRINGTON & SMITH, PC, 4 RESEARCH DRIVE, SHELTON, CT, 06484-6212, US

(21) Appl. No.: 10/591,828

(22) PCT Filed: Mar. 11, 2004
(86) PCT No.: PCT/IB04/01053

§ 371 Date: Aug. 6, 2007

(51) Int. Cl. H04L 12/28

(52) U.S. Cl. 370/400

(57) ABSTRACT

A method of creating autonomous musical output: including creating a mutually inhibiting neuronal network including a plurality of nodes arranged to integrate and fire; associating each of the plurality of nodes with a musical instrument; and creating, when a node fires, a musical output corresponding to the musical instrument associated with the firing node.

### FIELD OF THE INVENTION

Embodiments of the invention relate to generating autonomous musical output using a mutually inhibited neuronal network.

### BACKGROUND TO THE INVENTION

“A Method of Generating Musical Motion Patterns”, a Doctoral Dissertation, Hakapaino, Helsinki, 2000 by Pauli Laine describes in detail the autonomous creation of music using a central pattern generator and, in particular, a mutually inhibited neuronal network (MINN). This methodology described in the dissertation was unable to reliably produce good musical patterns and it easily generated chaotic patterns that were without noticeable periodicity. It was also difficult it to generate patterns with longer period-lengths (like 16-32 or 64) or with sub-periods (for example a larger period 64 and inside that patterns of 8).

It would be desirable to provide an improved mechanism and method for autonomously producing music.

### BRIEF DESCRIPTION OF THE INVENTION

Embodiments of the invention are able to generate very long and ‘musical’ output that does not easily become non-periodic and has sub-periods.

### BRIEF DESCRIPTION OF THE DRAWINGS

For a better understanding of the present invention reference will now be made by way of example only to the accompanying drawings in which:

FIG. 1 illustrates a network object; and

FIG. 2 illustrates a graphical user interface.

### DETAILED DESCRIPTION OF EMBODIMENTS OF THE INVENTION

An artificial neuronal network (ANN) is a set of connected computational nodes. In embodiments of the invention, the network is not a learning network in which changes in connection weights are inspected but is a small network of between 5 and 50 nodes (typically) in which the dynamic firing behavior of the network is inspected in detail at regular intervals.

Each node can be connected to receive a neuronal impulse or impulses, output from one or more other nodes, and each node can be connected to provide as output a neuronal impulse to one or more other nodes.

A neuronal impulse received at a node can have an activation or an inhibitory effect depending upon whether the connection on which the neuronal impulse is received is an activation connection or an inhibitory connection. An activation effect increases the activation level of the node according to a simple activation function, such as a sigmoid function. An inhibiting effect inhibits or prevents an increase in the activation level of the node. When the node's activation level reaches a threshold value, the node fires and produces a neuronal impulse as output. After firing the activity level of the node quickly goes to zero or a low non-zero value depending upon implementation.

An input impulse received at a node may be a neuronal impulse output from a connected node or may be one of a plurality of excitory impulses provided across the network according to a predetermined pattern. These excitory impulses have an activation effect. They increase the activity of the network and may be provided to all or some of the nodes of the network at each interval.

An additional feature of the described neuronal network model is the vanishing (excitation) parameter. If the vanishing (excitation) parameter is zero or not implemented, then if there is no excitory or neuronal activation input the activation level of the node would remain constant. However, in the preferred implementation, the current activation level is multiplied by the vanishing (excitation) parameter value, which is may be grater or less than 1 and is typically a value between 0.5 to 1.2. If the vanishing parameter is greater than 1, then after a certain time, and even without any input, the activation level reaches the threshold and the node fires, after that the activation level decreases to or near to zero depending upon implementation. This feature introduces self-oscillation, which enhances the periodicity of the network output. If the vanishing parameter is below 1 there is no self-oscillation.

The presence of multiple inhibitory and activation connections in the neuronal network creates a neuronal central pattern generator (CPG), which makes a dynamic oscillating pattern in two dimensions that has cycles within cycles. The dimensions include time and space i.e. the timing at which nodes fire and the identity of the nodes that fire. The dynamic pattern of what nodes fire when, produced by the CPG, is translated into real-time music that has cycles within cycles. The neuronal network therefore creates music without any random operation, and it is deterministic and controllable.

The two dimensional oscillating pattern can be represented by dividing time into a series of intervals and identifying the nodes that fire in each respective interval.

Network Model

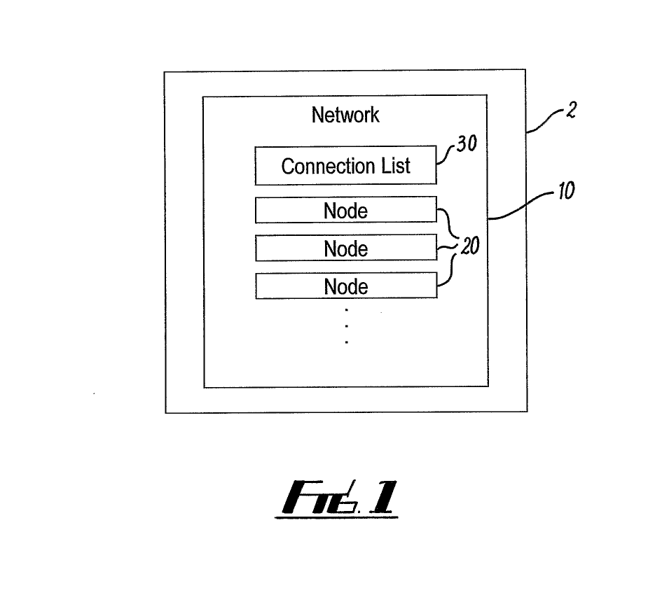

Referring to FIG. 1, the artificial neuronal network is modeled as a network object 10 in a computer program 2. The network object 10 comprises a plurality of integrate-and-fire node objects 20 that respectively represent each of the nodes of the network.

The connections of the network are maintained in a connection list 30 that comprises, for each node, pointers to the nodes that provide activation inputs and pointers to the nodes that provide inhibitory inputs.

The network object 10 defining the neuronal network is updated at each time interval. This involves providing excitory input impulses to the network nodes according to a predetermined pattern; calculating the excitation level of each node; determining which nodes fire; and translating the identity of the nodes that fire into a musical output.

Determining which nodes fire when depends upon the calculation of the excitation level of each node, which occurs at each node object 20 at each interval. Each node object computes for each interval, using an activation function, its activation level for that interval. The computation takes as its inputs the activation neuronal impulses, which the node received in the previous interval from connected nodes that fired in that previous interval, the inhibitory effect of inhibitory connections, the excitory input impulse received (if any) and a vanishing (excitation) parameter.

The activation neuronal impulses, which the node received in the previous interval from connected nodes that fired in that previous interval (if any), increase the excitation level of the node. Let the energy received from activation neuronal impulses in the time interval n be received_neuronal_impulse_energy(n).

The excitory input impulse received (if any) increase the excitation level of the node. Let the energy received from excitory input impulses at the time interval n be received_excitory_impulse_energy(n).

An inhibitory connection may reduce the excitation level of the node depending on the status of the node it is connected to. For example, if that node has a higher activation energy it will inhibit the increase in the excitation level of the node. Let the energy cost of the inhibitory connections at the time interval n be inhibition_cost(n).

The vanishing (excitation) parameter is used as a multiplying factor for the resultant calculated excitation level. If it is greater than 1 it increases the excitation level of the node and if it is less than 1 it decreases the excitation level of the node. Let the vanishing parameter at the time interval n be vanishing(n).

The activation calculation can then be coded as:
temp_activation level (n)=received_neuronal_impulse_energy(n)+received_excitory_impulse_energy (n)+new_activation level (n−1)
temp_activation level (n)=temp_activation level (n)−inhibition_cost(n)
new_activation_level(n)=vanishing(n)*sigmoid(temp_activation_level (n))
If the resultant computed activation level (new activation_level(n)) exceeds a threshold value, then the node fires.

The two dimensional oscillating pattern produced by the neuronal network is translated into a musical output. This is achieved by associating each node or each subset of the network nodes with a single percussive group/instrument. The subsets are preferably, but not necessarily, non-overlapping. A sub-set of nodes is typically a group of adjacent nodes. For example, if the music produced is drum music then each sub-set of nodes would be associated with, for example, one of Base drum, snare drum, hi hat, cymbal, tom drum, bong, percussion

For each interval, the firing of the nodes in that interval are mapped in real-time to the sub-sets that contains those nodes. The identified sub-sets are then each mapped to a percussive group identity that is provided to a MIDI synthesizer.

User Control

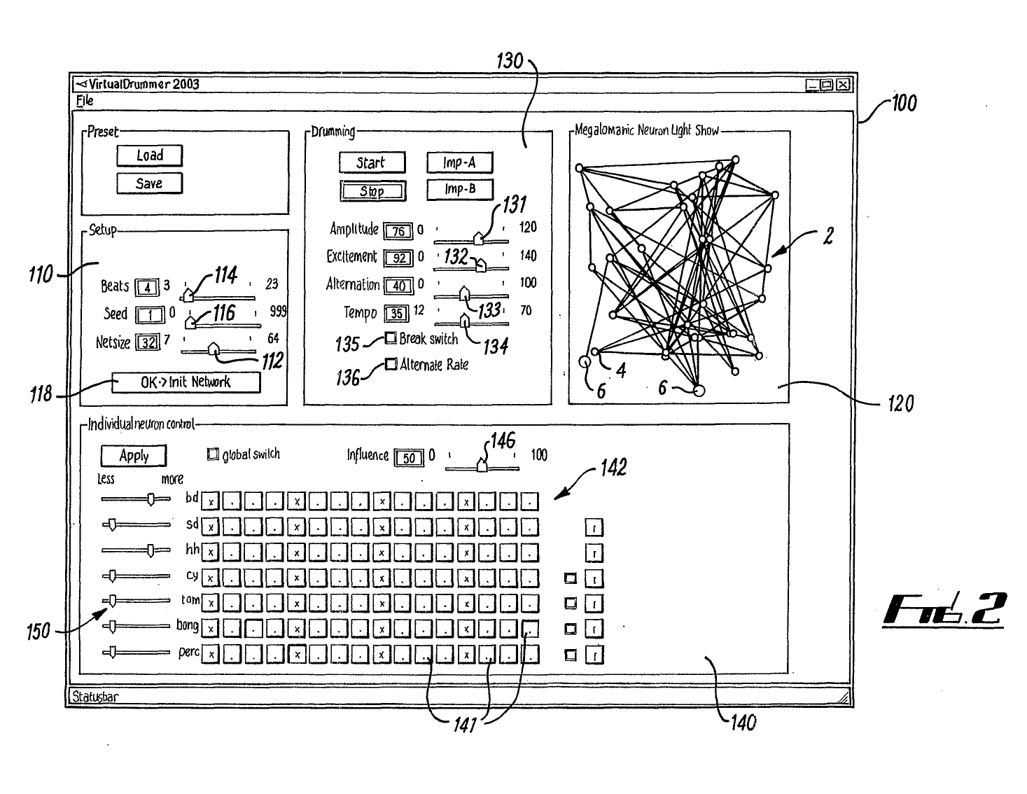

The output of the neuronal network can be deterministically controlled via a graphical user interface 100 illustrated in FIG. 2.

The graphical user interface comprises a Setup control panel 110 that allows a user to program values for ‘Beats’, ‘Seed’ and ‘Netsize’.

‘Netsize’ specifies the number of nodes in the network. The user can, in this example, vary the number of node in the network between 7 and 64 by adjusting the ‘Netsize’ slider 112.

‘Beats’ specifies the number of beats to a musical bar and is used to set the musical signature such as 4/4 time or ¾ time. The user can set the value of ‘Beats’ by adjusting the ‘Beats’ slider 114 between 3 and 23. This value determines the layout of the node control panel 140 and in particular the number of buttons 141 in each row of the array 142.

The ‘Seed’ slider 116 can be set by the user to determine a seed for the random generation of the network connections between nodes.

The button 118 initializes the network. When initialized, a schematic illustration of the network 2 is illustrated in a graphical display panel 120. The schematic display of the network 2 comprises a plurality of nodes 4. In the illustrated example, there are 32 nodes corresponding to the programmed value of ‘Netsize’. When a node 4 fires it is highlighted by illumination 6.

The graphical user interface 100 also comprises a network control panel 130. that comprises an ‘Amplitude’ slider 131, an ‘Excitation’ slider 132, an ‘Alternation’ slider 133 and a ‘Tempo’ slider 134.

The ‘Amplitude’ slider 131 may be adjusted by the user to vary the musical output in real-time. The value of ‘Amplitude’ can be adjusted to be between 0 and 120. This parameter value increases the excitory effect of neuronal activation impulses and excitory impulses on all the nodes of the network. Increasing the value generally increases the network activity and the effect of the node control panel 140 settings on the musical output.

The ‘Excitement’ slider 132 may be adjusted by the user to vary the musical output in real-time. The value of ‘Excitement’ can be adjusted between 0 and 140. This parameter varies the vanishing (excitement) parameter that controls the preservation of energy and the self-oscillation of nodes. Increasing the value generally increases network activity without increasing the effect of the node control panel 140 settings on the musical output.

The ‘Alternation’ slider 133 may be adjusted by the user to vary the musical output in real-time. The value of ‘Alternation’ can be adjusted between 0 and 100. This parameter varies the connection weight between nodes and controls the inhibition strength of inhibitory connections. Increasing the value generally increases the rigidity and repeatability of the musical output.

The ‘Tempo’ slider 134 may be adjusted by the user to vary the musical output in real-time. The value of ‘Tempo’ can be adjusted between 0 and 70. Tempo controls the duration of an interval.

A Break Switch option 135 can be selected by a user. When selected a simple break or fill-in is provided at an appropriate position such as every 2^{nd}, 4^{th} or 8^{th} bar at the second half of the respective bars, the excitation parameter is enhanced momentarily by 10% and ‘amplitude’ is increased by 5%. This creates more energetic drumming, the rhythm of which depends upon the overall network situation at the time.

An Alternate Rate option 136 controls the rate at which inhibition is calculated. When it is not selected inhibition is calculated every interval but when it is selected inhibition is calculated every second interval.

A node control panel 140 allows a user to control the pattern of the excitory input impulses and its variation in time.

The control panel 140 comprises an energy table 142 comprising and N row by M column array of user selectable buttons 141. Each row of the array corresponds to a different group of nodes. Each column corresponds to a portion of a musical bar and the value M is determined by the ‘Beats’ parameter 114.

Each button 141 allows a user to determine whether the excitory input impulse applied to a sub-set of neurons has a low value or a high value at a particular interval. Selecting a button 142 sets the excitory input impulse to a high value.

The ‘influence’ slider 146 is movable by a user during operation of the program and it determines the difference between a low value and a high value. If ‘influence’ is set close to 100% the musical output would be almost dictated by the energy table 142 configuration, whereas if influence is close to 0% the generated musical output would be based on the CPG network internal dynamics only.

The sliders 150 allow a user to adjust the sensitivity of different neuron groups to both excitory inputs and neuronal inputs. There is a different slide associated with each row. In practice, this allows a user to make certain groups of neurons more sensitive to the pattern of excitory impulses programmed in the respective row of the energy table 142.

The pattern of which nodes are excited when is determined by selecting different ones of the buttons 141. The slider 146 determine the difference in effect between selecting and not selecting a button. The sensitivity of the different node groups to inputs is set by adjusting the sliders 150.

At set-up the user defines the set-up parameters using the set-up control panel 110. The program then randomly creates connections between the nodes. Nodes are interconnected in such a way that each neuron's activity level inhibits growth of some other neuron's activity level.

The program initializes the other parameters in the network control panel 130 and the neuron control panel 140 at default values, which the user can modify while the program is running. The network object is then updated at each interval and a music output is created in real-time at each interval.

The user can therefore increase the activity of the music by increasing ‘Amplitude’ 131 and/or ‘Excitement’ 140, the user can vary the stability of the music by changing ‘Alternation’ 133 and the user can vary the tempo of the music by varying ‘Tempo’ 134.

The user can also vary the pattern of excitory impulses provided to each group of nodes using the buttons 141 and slider 146 and their sensitivity to such input by adjusting the sliders 150. Once a desired musical style is achieved, it can be stored and recalled later if desired.

The neuron control panel 140 can be used to program a style of music. For example (simplified rock) would be:
Hihat x o x o x o x o
Bass x o o o x o o o
Snare o o x o o o x o

It would be a simply modification to the illustrated graphical user interface to include a drop-down menu for selecting different musical styles. The selection of a particular style would automatically program the energy table 142 of the neuron control panel 140 with the appropriate configuration i.e. which of the buttons 141 are depressed.

Although embodiments of the present invention have been described in the preceding paragraphs with reference to various examples, it should be appreciated that modifications to the examples given can be made without departing from the scope of the invention as claimed. For example, although in the described embodiment the tempo is set according to a slider 134, in alternative embodiments the tempo may be set by tapping a key or by shaking a device or from some other input. For example a heart rate sensor may provide the tempo or the most prominent (bass-drum) drum beat is synchronized with the heart pulse. The heart pulse rate may alternatively be used to control the interval between excitory impulses. As the heart rate increases, the interval decreases and as the heart rate decreases, the interval increases. Consequently, music can be generated during physical activity that changes with the activity level of the user. The changes to the music as the activity level changes are not just in the music tempo, but in the pattern of the music that is generated. The history of the heart rate may also be used as an input parameter and pattern of music generated may depend upon the user identify a type of sport.

The above described methodology may be used to compose a ring-tone for a mobile telephone.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of creating autonomous musical output comprising:
creating a mutually inhibiting neuronal network comprising a plurality of nodes arranged to integrate and fire;
associating each of the plurality of nodes with a musical instrument; and
creating, when a node fires, a musical output corresponding to the musical instrument associated with the firing node.

2. A method as claimed in claim 1, wherein the plurality of nodes is comprised of a plurality of subsets of the plurality of nodes and each sub-set is associated with a single, different percussive group.

3. A method as claimed in claim 2, wherein each sub-set is a grouping of adjacent ones of the plurality of nodes.

4. A method as claimed in claim 2, wherein the plurality of nodes is comprised of eight sub-sets and each sub-set is associated with one of: Base drum, snare drum, hi hat, cymbal, tom drum, bong, percussion.

5. A method as claimed in claim 1, comprising:
changing the musical output by changing the musical instrument to which a node is associated.

6. A method as claimed in claim 1, comprising:
exciting some or all of the plurality of nodes according to a pattern that determines what level of excitement is provided to which nodes at different times.

7. A method as claimed in claim 6, comprising changing the musical output by changing the pattern.

8. A method as claimed in claim 7, wherein a user changes the pattern by selecting what level of excitement is provided to which nodes at different times.

9. A method as claimed in claim 1 further comprising, at each one of a plurality of sequential periods of time:
calculating an excitation level for each of the plurality of nodes;
determining from the calculated excitation level which nodes fire in the current interval of time;
translating the identity of the nodes that fire in the current interval of time into a real-time musical output comprising notes of the musical instruments associated with the firing nodes.

10. A method as claimed in claim 9, comprising, after a node fires, preventing it from subsequently firing for at least a delay period.

11. A method as claimed in claim 10, wherein the delay period duration is user programmable.

12. A method as claimed in claim 9, wherein calculation of the excitation level of a node at a first interval is dependent upon whether the node was excited, in the preceding interval, by the firing of a node or nodes to which it is connected by an activation connection.

13. A method as claimed in claim 9, comprising:
providing excitory impulses to the plurality of nodes according to a predetermined pattern that determines what impulses are provided to which nodes at different times,
wherein calculation of the excitation level of a node at a first interval is dependent upon an excitory input impulse received by the node at the first interval.

14. A method as claimed in claim 9, wherein calculation of the excitation level of a node at a first interval involves multiplying the current or previous excitation level by a factor.

15. A method as claimed in claim 14, wherein the factor is greater than 1.

16. A method as claimed in claim 15, wherein the factor is user programmable.

17. A method as claimed in claim 9, wherein the calculation of the excitation level of a node at a first interval is dependent upon the node or nodes to which it is connected by an inhibitory connection.

18. A method as claimed in claim 1 wherein the step of creating a mutually inhibiting neuronal network comprises user specification of the number of nodes in the network.

19. A method as claimed in claim 1 wherein the step of creating a mutually inhibiting neuronal network comprises user specification of the tempo of the musical output.

20. A method as claimed in claim 1 further comprising:
displaying a visual representation of each node of the network;
displaying an indication when a node fires;
and simultaneously providing, for each firing node, musical output corresponding to the musical instrument associated with the firing node.

21. A Computer program comprising instructions for carrying out the method of claim 1.

22. A method of creating autonomous musical output comprising:
creating a mutually inhibiting neuronal network comprising a plurality of nodes arranged to integrate and fire;
associating each of the plurality of nodes with a particular musical output; and
exciting some or all of the plurality of nodes according to a predetermined pattern that determines what level of excitement is provided to which nodes at different times.

23. A method as claimed in claim 22, comprising changing the musical output by changing the predetermined pattern.

24. A method as claimed in claim 23, wherein a user changes the predetermined pattern by selecting what level of excitement is provided to which nodes at different times.

25. A method as claimed in claim 22, wherein the step of associating each of the plurality of nodes with a musical output associates each of the plurality of nodes with a musical instrument, the method further comprising:
creating, when a node fires, a musical output corresponding to the musical instrument associated with the firing node.

26. A method as claimed in claim 25, wherein the plurality of nodes is comprised of a plurality of non-overlapping subsets of the plurality of nodes and each sub-set is associated with a single, different percussive group.

27. A method as claimed in claim 26, wherein each sub-set is a grouping of adjacent ones of the plurality of nodes.

28. A method as claimed in claim 26, wherein the plurality of nodes is comprised of eight non-overlapping sub-sets and each sub-set is associated with one of: Base drum, snare drum, hi hat, cymbal, tom drum, bong, percussion.

29. A method of creating autonomous musical output comprising:
creating a mutually inhibiting neuronal network comprising a plurality of nodes arranged to integrate and fire; and at each one of a plurality of sequential time intervals:
calculating an excitation level for each of the plurality of nodes wherein said calculation involves, for at least some of the nodes, multiplying the excitation level of the node at the previous time interval by a factor;
determining from the calculated excitation level which nodes fire in the current time interval; and
translating the identity of the nodes that fire in the current time interval into a real-time musical output.

30. A method as claimed in claim 29, wherein the factor is greater than 1.

31. A method as claimed in claim 29, wherein the factor is user programmable.

32. A method of providing a visual representation of the music comprising displaying a plurality of nodes;
associating each node with a musical instrument; and
highlighting a node when contemporaneously output music comprises a note of the instrument associated with that node.

33. A method of contemporaneously generating music comprising: upon a persons heart rate, comprising:
measuring a persons heart rate;
providing the measured heart rate as an input to a musical central pattern generator.

34. A method for contemporaneously generating an oscillating output comprising:
creating a mutually inhibiting neuronal network comprising a plurality of nodes arranged to integrate and fire;
exciting some or all of the plurality of nodes according to a pattern that determines what level of excitement is provided to which nodes at different times; and measuring a persons heart rate and changing the pattern in dependence upon the measured heart rate.

35. (canceled)

36. (canceled)

37. A network for creating autonomous musical output comprising:
a plurality of nodes arranged to integrate and fire; wherein each of the plurality of nodes is associated with a musical instrument such that when the node fires a musical output corresponding to the musical instrument is created.

38. A node for communicating in a network wherein:
the node is arranged to integrate and fire and is associated with a musical instrument such that when the node fires a musical output corresponding to the musical instrument is created.

39. A user interface for enabling a method of creating autonomous musical output, the method comprising:
creating a mutually inhibiting neuronal network comprising a plurality of nodes arranged to integrate and fire;
associating each of the plurality of nodes with a musical instrument; and
creating, when a node fires, a musical output corresponding to the musical instrument associated with the firing node.
